(19) United States
(12) Patent Application Publication
(10) Pub. No.: US 2021/0334604 A1
(43) Pub. Date: Oct. 28, 2021

(54) FACIAL RECOGNITION METHOD AND APPARATUS

(71) Applicant: BEIJING SENSETIME TECHNOLOGY DEVELOPMENT CO., LTD., Beijing (CN)

(72) Inventor: Zhipeng YU, Beijing (CN)

(21) Appl. No.: 17/370,352

(22) Filed: Jul. 8, 2021

Related U.S. Application Data
(63) Continuation of application No. PCT/CN2019/114432, filed on Oct. 30, 2019.

(30) Foreign Application Priority Data
Mar. 22, 2019 (CN) 201910220321.5

(51) Int. Cl. G06K 9/62; G06K 9/46; G06N 3/04; G06N 3/08

(52) U.S. Cl. CPC G06K 9/6265; G06K 9/6257; G06N 3/08; G06K 9/6279; G06N 3/0454; G06K 9/46

(57) ABSTRACT

A face recognition method includes: acquiring an image to be recognized; and recognizing the image to be recognized based on a cross-modal face recognition network to obtain a recognition result of the image to be recognized, wherein the cross-modal face recognition network is obtained by training based on face image data in different modalities.

### CROSS-REFERENCE TO RELATED APPLICATIONS

This application is a continuation of International Application No. PCT/CN2019/114432, filed on Oct. 30, 2019, which claims priority to Chinese Patent Application No. 201910220321.5, filed on March 22, 2019. The disclosures of International Application No. PCT/CN2019/114432 and Chinese Patent Application No. 201910220321.5 are hereby incorporated by reference in their entireties.

### BACKGROUND

In the fields of security, social security, communication and the like, it is necessary to recognize whether target persons in different images are the same person or not to implement operations of face tracking, real-name authentication, phone unlocking and the like. At present, face recognition may be performed on target persons in different images through a face recognition algorithm to recognize whether the target persons in the different images are the same person or not, but the recognition accuracy is relatively low.

### SUMMARY

Embodiments of the disclosure relate to the technical field of image processing, and particularly to a face recognition method and device.

The disclosure provides a face recognition method, to recognize whether target persons in different images are the same person or not.

A first aspect provides a face recognition method, which may include that: an image to be recognized is acquired; and the image to be recognized is recognized based on a cross-modal face recognition network to obtain a recognition result of the image to be recognized, where the cross-modal face recognition network is obtained by training based on face image data in different modalities.

A second aspect provides a face recognition device, which may include a memory storing processor-executable instructions, and a processor configured to execute the stored processor-executable instructions to perform operations of: acquiring an image to be recognized; and recognizing the image to be recognized based on a cross-modal face recognition network to obtain a recognition result of the image to be recognized, wherein the cross-modal face recognition network is obtained by training based on face image data in different modalities.

A third aspect provides a non-transitory computer-readable storage medium having stored thereon instructions that, when executed by a processor, cause the processor to perform operations of: acquiring an image to be recognized; and recognizing the image to be recognized based on a cross-modal face recognition network to obtain a recognition result of the image to be recognized, wherein the cross-modal face recognition network is obtained by training based on face image data in different modalities.

It is to be understood that the above general description and the following detailed description are only exemplary and explanatory and not intended to limit the disclosure.

### BRIEF DESCRIPTION OF THE DRAWINGS

In order to describe the technical solutions in the embodiments of the disclosure or a background art more clearly, the drawings required to be used for descriptions about the embodiments of the disclosure or the background art will be described below.

The accompanying drawings, which are incorporated in and constitute a part of this specification, illustrate embodiments consistent with the disclosure and, together with the specification, serve to describe the technical solutions of the disclosure.

FIG. 1 is a flowchart of a face recognition method according to an embodiment of the disclosure.

FIG. 2 is a flowchart of training a first modal network based on a first image set and a second image set according to an embodiment of the disclosure.

FIG. 3 is a flowchart of another face recognition neural network training method according to an embodiment of the disclosure.

FIG. 4 is a flowchart of another face recognition neural network training method according to an embodiment of the disclosure.

FIG. 5 is a flowchart of training a neural network based on image sets obtained by categorization according to races according to an embodiment of the disclosure.

FIG. 6 is a structure diagram of a face recognition device according to an embodiment of the disclosure.

FIG. 7 is a hardware structure diagram of a face recognition device according to an embodiment of the disclosure.

### DETAILED DESCRIPTION

In order to make the solutions of the disclosure understood by those skilled in the art, the technical solutions in the embodiments of the disclosure will be clearly and completely described below in combination with the drawings in the embodiments of the disclosure. It is apparent that the described embodiments are not all embodiments but only part of embodiments of the disclosure. All other embodiments obtained by those of ordinary skill in the art based on the embodiments in the disclosure without creative work shall fall within the scope of protection of the disclosure.

Terms “first”, “second” and the like in the specification, claims and drawings of the disclosure are adopted not to describe a specific sequence but to distinguish different objects. In addition, terms “include” and “have” and any transformations thereof are intended to cover nonexclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

“Embodiment” mentioned herein means that a specific feature, structure or characteristic described in combination with an embodiment may be included in at least one embodiment of the disclosure. Each position where this phrase appears in the specification does not always refer to the same embodiment as well as an independent or alternative embodiment mutually exclusive to another embodiment. It is explicitly and implicitly understood by those skilled in the art that the embodiments described in the disclosure may be combined with other embodiments.

In some embodiments of the disclosure, the number of persons is different from the number of target persons. For example, if an image A includes two objects, i.e., Zhang San and Li Si respectively, an image B includes one object, i.e., Zhang San, and an image C includes two objects, i e , Zhang San and Li Si respectively, a number of persons in the image A, the image B and the image C is 2 (Zhang San and Li Si), and the number of the objects in the image A, the image B and the image C is 2+1+2=5, namely the number of the persons is 5.

In order to describe the technical solutions in the embodiments of the disclosure or a background art more clearly, the drawings required to be used for descriptions about the embodiments of the disclosure or the background art will be described below.

The embodiments of the disclosure will be described below in combination with the drawings in the embodiments of the disclosure.

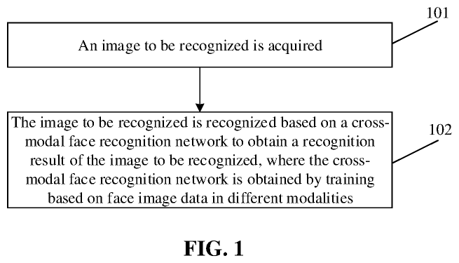

Referring to FIG. 1, FIG. 1 is a flowchart of a face recognition method according to an embodiment of the disclosure.

In operation 101, an image to be recognized is acquired. In some embodiments of the disclosure, the image to be recognized may be an image set stored in a local terminal (for example, a mobile phone, a tablet computer and a notebook computer), or any frame of image in a video may be determined as the image to be recognized, or a face region image is detected from any frame of image in the video and the face region image is determined as the image to be recognized.

In operation 102, the image to be recognized is recognized based on a cross-modal face recognition network to obtain a recognition result of the image to be recognized, wherein, the cross-modal face recognition network is obtained by training based on face image data in different modalities. In some embodiments of the disclosure, the cross-modal face recognition network may recognize images including objects of different categories. For example, whether objects in two images are the same person or not may be recognized. The categories may be divided according to ages of persons, may also be divided according to races and may also be divided according to districts. For example, zero-year-old to three-year-old persons may be categorized as a first category, four-year-old to ten-year-old persons may be categorized as a second category, eleven-year-old to twenty-year-old persons may be categorized as a third category, and so on. Or, the yellow race may be categorized as the first category, the white race may be categorized as the second category, the black race may be categorized as the third category, and the brown race may be categorized as a fourth category. Or, persons in China may be categorized as the first category, persons in Thailand may be categorized as the second category, persons in India may be categorized as the third category, persons in Cairo may be categorized as the fourth category, persons in Africa may be categorized as a fifth category, and persons in the Europe may be categorized as a sixth category. Category division is not limited in some embodiments of the disclosure.

In some examples, a face region image, collected by a camera of a mobile phone, of an object and a pre-stored face region image are input to a face recognition neural network as an image set to be recognized to recognize whether objects in the image set to be recognized are the same person or not. In some other examples, a camera A collects a first image to be recognized at a first moment, a camera B collects a second image to be recognized at a second moment, and whether objects in the two images to be recognized are the same person or not is recognized. In some embodiments of the disclosure, the face image data in the different modalities refers to image sets including objects of different categories. The cross-modal face recognition network is obtained by taking face image sets in different modalities as a training set for pre-training. The cross-modal face recognition network may be any neural network with a function of extracting features from images. For example, it may be stacked or formed based on network units such as a convolutional layer, a nonlinear layer and a fully connected layer according to a certain manner, and may also adopt an existing neural network structure. A structure of the cross-modal face recognition network is not specifically limited in the disclosure.

In a possible implementation, two images to be recognized are input to the cross-modal face recognition network, and the cross-modal face recognition network performs feature extraction processing on the images to be recognized to obtain different features respectively, then compares the extracted features to obtain a feature matching degree, recognizes that objects in the two images to be recognized are the same person under the condition that the feature matching degree reaches a feature matching degree threshold, otherwise recognizes that the objects in the two images to be recognized are not the same person under the condition that the feature matching degree does not reach the feature matching degree threshold. In some embodiments, a neural network is trained through image sets divided according to categories to obtain the cross-modal face recognition network, and whether objects of each category are the same person or not is recognized through the cross-modal face recognition network, so that the recognition accuracy may be improved.

The following embodiments are some examples of 102 in the face recognition method provided in the disclosure.

The cross-modal face recognition network is obtained by training based on a first modal network and a second modal network. The first modal network and the second modal network may be any neural networks with the function of extracting features from images. For example, each of them may be stacked or formed based on network units such as a convolutional layer, a nonlinear layer and a fully connected layer according to a certain manner, and may also adopt an existing neural network structure. The structure of the cross-modal face recognition network is not specifically limited in the disclosure. In some examples, the first modal network and the second modal network are trained by taking different image sets as training sets respectively to enable the first modal network to learn features of objects of different categories, and then the features learned by the first modal network and the second modal network are aggregated to obtain the cross-modal network, so that the cross-modal network may recognize objects of different categories. Optionally, before the cross-modal face recognition network is obtained by training based on the first modal network and the second modal network, the first modal network is trained based on a first image set and a second image set. Objects in the first image set and the second image set may only include faces and may also include the faces and other parts such as trunks. No specific limits are made thereto in the disclosure. In some examples, the first modal network is trained by taking the first image set as a training set to obtain the second modal neural network, so that the second modal network may recognize whether objects in multiple images including the objects of a first category are the same person or not; and the second modal network is trained by taking the second image set as a training set to obtain the cross-modal face recognition network, so that the cross-modal face recognition network may recognize whether objects in multiple images including the objects of the first category are the same person or not and whether objects in multiple images including the objects of a second category are the same person or not. Therefore, the cross-modal face recognition network may recognize an object of the first category at a high recognition rate and may also recognize an object of the second category at a high recognition rate.

In some other examples, the first modal network is trained by taking all images in the first image set and the second image set as the training set to obtain the cross-modal face recognition network, so that the cross-modal face recognition network may recognize whether objects in multiple images including the objects of the first category or the second category are the same person or not. In some other examples, the training set is obtained by selecting a images from the first image set and selecting b images from the second image set, a:b meeting a preset ratio, and then the first modal network is trained based on the training set to obtain the cross-modal face recognition network, so that the recognition accuracy of the cross-modal face recognition network in recognizing whether target persons in multiple images including objects of the first category or the second category are the same person or not is high.

The cross-modal face recognition network determines whether objects in different images are the same person or not through feature matching degrees. Face features of persons of different categories may be greatly different, so that feature matching degree thresholds (if the thresholds are reached, persons are recognized as the same person) for persons of different categories are different. In the training method provided in some embodiments, the image sets including objects of different categories are adopted for training, so that a difference between feature matching degrees for recognition of target persons of different categories by the cross-modal face recognition network may be reduced.

In some embodiments, the neural network (the first modal network and the second modal network) is trained through the image sets divided according to the categories to enable the neural network to simultaneously learn face features of objects of different categories, and whether objects of each category are the same person or not is recognized through the cross-modal face recognition network obtained by training, so that the recognition accuracy may be improved. The neural network is simultaneously trained through the image sets of different categories, so that a difference between recognition standards for recognition of target persons of different categories by the neural network may be reduced.

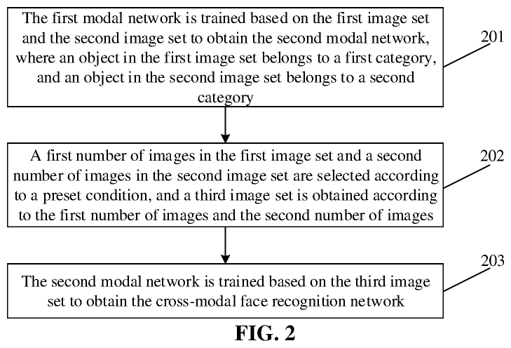

Referring to FIG. 2, FIG. 2 is a flowchart of some examples of training a first modal network based on a first image set and a second image set according to an embodiment of the disclosure.

In operation 201, the first modal network is trained based on the first image set and the second image set to obtain the second modal network, where an object in the first image set belongs to a first category, and an object in the second image set belongs to a second category. In some embodiments of the disclosure, the first modal network may be acquired in multiple manners. In some examples, the first modal network may be acquired from another device, for example, the first modal network sent by a terminal device is received. In some other examples, the first modal network is stored in the local terminal, and the first modal network may be called from the local terminal. As mentioned above, the first category in the first image set is different from the second category in the second image set, and the first modal network is trained based on the first image set and the second image set respectively, so that the first modal network may learn features of the first category and the second category, and the accuracy of recognizing whether the objects of the first category and the second category are the same person or not is improved. In some examples, the objects in the first image set are eleven-year-old to twenty-year-old persons, and the objects in the second image set are twenty-year-old to thirty-year-old persons. The recognition accuracy of the second modal network obtained by training the first modal network by taking the first image set and the second image set as the training set for eleven-year-old to twenty-year-old objects and twenty-year-old to thirty-year-old objects is high.

In operation 202, a first number of images in the first image set and a second number of images in the second image set are selected according to a preset condition, and a third image set is obtained according to the first number of images and the second number of images. Since a difference between a feature of the first category and a feature of the second category is relatively great, a recognition standard for recognizing whether objects of the first category are the same person or not by the neural network and a recognition standard for recognizing whether objects of the second category are the same person or not may also be different. The recognition standard may be a matching degree of extracted features of different objects. For example, since features of the five organs and facial contours of the zero-year-old to three-year-old persons are less obvious than features of the five organs and facial contours of the twenty-year-old to thirty-year-old persons, the neural network learns more features of zero-year-old to three-year-old objects than features of twenty-year-old to thirty-year-old objects in the training process, and the trained neural network requires a higher feature matching degree to recognize whether zero-year-old to three-year-old objects are the same person or not. For example, when whether zero-year-old to three-year-old objects are the same person or not is recognized, it is determined that two objects of which a feature matching degree is more than or equal to 0.8 are the same person, and it is determined that two objects of which a feature matching degree is less than 0.8 are not the same person. When the neural network recognizes whether twenty-year-old to thirty-year-old objects are the same person or not, it is determined that two objects of which a feature matching degree is more than or equal to 0.65 is the same person, and it is determined that two objects of which a feature matching degree is less than 0.65 are not the same person. In such case, if twenty-year-old to thirty-year-old objects are recognized by use of the recognition standard for zero-year-old to three-year-old objects, two objects that are the same person are likely to be recognized as different persons, and conversely, if zero-year-old to three-year-old objects are recognized by use of the recognition standard for twenty-year-old to thirty-year-old objects, two objects that are not the same person are likely to be recognized as the same person.

In some embodiments, the first number of images in the first image set and the second number of images in the second image set are selected according to the preset condition, and the first number of images and the second number of images form a training set, so that a ratio of features, learned by the second modal network in the training process, of different categories may be more balanced, and the difference between the recognition standards for objects of different categories may be reduced. In some examples, it is set that both the number of persons in the first number of images selected from the first image set and the number of persons in the second number of images selected from the second image set are X, and in such case, the numbers of the images selected from the first image set and the second image set are not limited as long as the numbers of the persons in the images selected from the first image set and the second image set respectively reach X.

In operation 203, the second modal network is trained based on the third image set to obtain the cross-modal face recognition network. The third image set includes the first category and the second category. The number of persons of the first category and the number of persons of the second category are selected according to the preset condition, and this is a difference of the third image set from a randomly selected image set. The second modal network is trained by taking the third image set as a training set, so that the second modal network may balance learning of features of the first category and learning of features of the second category better. In addition, if supervised training is performed on the second modal network, in the training process, a category of an object in each image may be divided through a softmax function, and a parameter of the second modal network is adjusted through a supervision tag, a categorization result and a loss function. In some examples, each object in the third image set corresponds to a tag. For example, tags of the same object in an image A and an image B are 1, and a tag of another object in an image C is 2. An expression of the softmax function is as follows:

$${S}_{j} = \frac{{e}^{{P}_{j}}}{{Σ}_{k = 1}^{t} {e}^{{p}_{k}}} . \qquad Formula ( 1 )$$

Herein, t is a number of persons in the third image set, Sⱼ is a probability that the object belongs to a category j, Pⱼ is a jth numerical value in feature vectors input to a softmax layer, and k is a kth numerical value in the feature vectors input to the softmax layer. A loss function layer including the loss function is connected after the softmax layer, a back propagation gradient of the second neural network to be trained may be obtained through a probability value output by the softmax layer, the tags of the third image set and the loss function, and then gradient back propagation may be performed on the second neural network to be trained according to the back propagation gradient to obtain the cross-modal face recognition network. Since the third image set includes objects of the first category and objects of the second category and the number of the persons of the first category and the number of the persons of the second category meet the preset condition, training the second modal network by taking the third image set as the training set may enable the second modal network to balance a learning ratio of facial features of the first category and facial features of the second category and further enable the jet finally obtained cross-modal face recognition network to recognize whether objects of the first category are the same person or not at a high recognition rate and also recognize whether objects of the second category are the same person or not at a high recognition rate. In some examples, an expression of the loss function may refer to the following formula:

L=−Σ₀^{t}yⱼ log Sⱼ Formula (2).

Herein, t is the number of the persons in the third image set, Sⱼ is the probability that a target person belongs to the category j, and yⱼ is a tag of the target person belonging to the category j in the third image set. For example, if the third image set includes an image of Zhang San and a tag is 1, a tag of an object is 1 if the object belongs to a category 1, and the tag of the object is 0 if the object belongs to any other category. In some embodiments of the disclosure, the first modal network is trained by taking the first image set and second image set divided according to the categories as the training set, so that the recognition accuracy of the first modal network for the first category and the second category is improved; and the second modal network is trained by taking the third image set as the training set, so that the second modal network may balance the learning ratio of the facial features of the first category and the facial features of the second category, and furthermore, the cross-modal face recognition network obtained by training may not only recognize whether objects of the first category are the same person or not with high recognition accuracy but also recognize whether objects of the second category are the same person or not with high recognition accuracy.

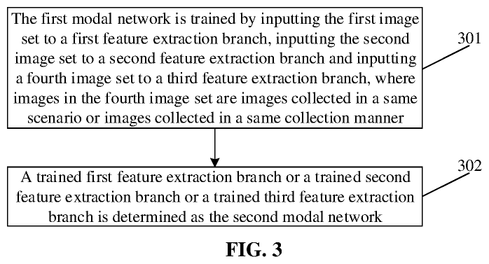

Referring to FIG. 3, FIG. 3 is a flowchart of a possible implementation of 201 according to an embodiment of the disclosure.

In operation 301, the first modal network is trained by inputting the first image set to a first feature extraction branch, inputting the second image set to a second feature extraction branch and inputting a fourth image set to a third feature extraction branch, where images in the fourth image set are images collected in a same scenario or images collected in a same collection manner In some embodiments of the disclosure, the images in the fourth image set are images collected in the same scenario or images collected in the same collection manner For example, all the images in the fourth image set are images shot by the mobile phone. For another example, all the images in the fourth image set are images shot indoors. For another example, all the images in the fourth image set are images shot at a port. The scenario and collection manner for the images in the fourth image set are not limited in some embodiments of the disclosure. In some embodiments of the disclosure, the first modal network includes the first feature extraction branch, the second feature extraction branch and the third feature extraction branch. Each of the first feature extraction branch, the second feature extraction branch and the third feature extraction branch may be any neural network structure with the function of extracting features from images. For example, it may be stacked or formed based on network units such as a convolutional layer, a nonlinear layer and a fully connected layer according to a certain manner, and may also adopt an existing neural network structure. Structures of the first feature extraction branch, the second feature extraction branch and the third feature extraction branch are not specifically limited in the disclosure. In some embodiments, the images in the first image set, the second image set and the fourth image set include first labeling information, second labeling information and third labeling information respectively. The labeling information includes a serial number of an object in the image. For example, the numbers of persons in the first image set, the second image set and the fourth image set are all Y (Y is an integer greater than 1), and a serial number corresponding to an object in any image in the first image set, the second image set and the fourth image set is any number between 1 and Y. It is to be understood that serial numbers of objects that are the same person in different images are the same. For example, if an object in an image A is Zhang San and an object in an image B is also Zhang San, serial numbers of the object in the image A and the object in the image B are the same, and if an object in an image C is Li Si, a serial number of the object in the image C is different from the serial number of the object in the image A. For making the facial features of the objects in each image set representative of facial features of the corresponding category, the number of the persons in each image set is optionally larger than 5,000. It is to be understood that the number of the images in the image set is not limited in some embodiments of the disclosure. In some embodiments of the disclosure, an initial parameter of the first feature extraction branch, an initial parameter of the second feature extraction branch and an initial parameter of the third feature extraction branch refer to a parameter of the first feature extraction branch not subjected to parameter adjustment, a parameter of the second feature extraction branch not subjected to parameter adjustment and a parameter of the third feature extraction branch not subjected to parameter adjustment respectively. Each branch of the first modal network includes the first feature extraction branch, the second feature extraction branch and the third feature extraction branch. The first image set is input to the first feature extraction branch, the second image set is input to the second feature extraction branch, and the fourth image set is input to the third feature extraction branch, namely the facial features of the objects in the first image set are learned by use of the first feature extraction branch, the facial features of the objects in the second image set are learned by use of the second feature extraction branch, and the facial features of the objects in the fourth image set are learned by use of the third feature extraction branch. Then, a back propagation gradient of each feature extraction branch is determined according to a softmax function and loss function of each feature extraction branch. Finally, a back propagation gradient of the first modal network is determined according to the back propagation gradient of each feature extraction branch, and the parameter of the first modal network is adjusted. It is to be understood that adjusting the parameter of the first modal network refers to adjusting the initial parameters of all the feature extraction branches. Since the back propagation gradients of each feature extraction branch are the same, the finally adjusted parameters are also the same. The back propagation gradient of each branch represents a parameter adjustment direction of each feature extraction branch, namely the parameters of the branches are adjusted through the back propagation gradients of the feature extraction branches, so that the accuracy of the feature extraction branches in recognizing objects of the corresponding categories (the same as the categories in the input image sets) may be improved. The parameter of the neural network is adjusted through the back propagation gradients of the first feature extraction branch and the second feature extraction branch, and the parameter adjustment direction of each branch may be integrated to obtain a balanced adjustment direction. Since the fourth image set includes images collected in a specific scenario or in a specific shooting manner, adjusting the parameter of the first modal network through the back propagation gradient of the third feature extraction branch may improve the robustness of the first modal network (namely the robustness to the image collection scenario and the image collection manner is high). The parameter of the first modal network is adjusted through the back propagation gradient obtained according to the back propagation gradients of the three feature extraction branches, so that the accuracy of any feature extraction branch in recognizing objects of the corresponding category (any one of the categories in the first image set and the second image set) is relatively high, and the robustness of any feature extraction branch to the image collection scenario and the image collection manner may be improved.

In some examples, the first image set is input to the first feature extraction branch, the second image set is input to the second feature extraction branch, the fourth image set is input to the third feature extraction branch, and feature extraction processing, processing of the fully connected layers and processing of the softmax layers are sequentially performed to obtain a first recognition result, a second recognition result and a third recognition result respectively. The softmax layer includes the softmax function, referring to the formula (1), and elaborations are omitted herein. The first recognition result, the second recognition result and the third recognition result include probabilities that the serial number of each object is different serial numbers. For example, if the numbers of the persons in the first image set, the second image set and the fourth image set are Y (Y is an integer greater than 1) and the serial number corresponding to the target person in any image in the first image set, the second image set and the fourth image set is any number between 1 and Y, then the first recognition result includes probabilities that the serial number of the target person in the first image set is 1 to Y respectively, namely the first recognition result of each object includes Y probabilities. Similarly, the second recognition result includes probabilities that the serial number of the object in the second image set is 1 to Y respectively, and the third recognition result includes probabilities that the serial number of the object in the fourth image set is 1 to Y respectively. In each branch, the loss function layer including the loss function is connected after the softmax layer. A first loss function of the first branch, a second loss function of the second branch and a third loss function of the third branch are acquired, a first loss is obtained according to the first labeling information, first recognition result and first loss function of the first image set, a second loss is obtained according to the second labeling information, second recognition result and second loss function of the second image set, and a third loss is obtained according to the third labeling information, third recognition result and third loss function of the fourth image set. The first loss function, the second loss function and the third loss function may refer to the formula (2), and will not be elaborated herein. The parameter of the first feature extraction branch, the parameter of the second feature extraction branch and the parameter of the third feature extraction branch are obtained. A first gradient is obtained according to the parameter and first loss of the first feature extraction branch, a second gradient is obtained according to the parameter and second loss of the second feature extraction branch, and a third gradient is obtained according to the parameter and third loss of the third feature extraction branch. The first gradient, the second gradient and the third gradient are the back propagation gradients of the first feature extraction branch, the second feature extraction branch and the third feature extraction branch respectively. The back propagation gradient of the first modal network is obtained according to the first gradient, the second gradient and the third gradient, and the parameter of the first modal network is adjusted in a gradient back propagation manner, so that the parameter of the first feature extraction branch, the parameter of the second feature extraction branch and the parameter of the third feature extraction branch are identical to each other. In some examples, an average value of the first gradient, the second gradient and the third gradient is determined as the back propagation gradient of the first neural network to be trained, and gradient back propagation is performed on the first modal network according to the back propagation gradient to adjust the parameter of the first feature extraction branch and the parameters of the second feature extraction branch and the third feature extraction branch, so that the parameters of the first feature extraction branch, second feature extraction branch and third feature extraction branch subjected to parameter adjustment are identical to each other.

In operation 302, a trained first feature extraction branch or a trained second feature extraction branch or a trained third feature extraction branch is determined as the second modal network. Through processing in operation 301, the parameters of the trained first feature extraction branch, the trained second feature extraction branch and the trained third feature extraction branch are the same, namely the recognition accuracy for the objects of the first category (the category in the first image set) and the second category (the category in the second image set) is high, and the robustness to recognition of images collected in different scenarios and images collected in different collection manners is high. Therefore, the trained first feature extraction branch or the trained second feature extraction branch or the trained third feature extraction branch is determined as a network for next-step training, i.e., the second modal network. In some embodiments of the disclosure, both the first image set and the second image set are image sets selected according to the categories, and the fourth image set is an image set selected according to the scenario and the collection manner The first feature extraction branch is trained through the first image set, so that the first feature extraction branch may emphatically learn the facial features of the first category. The second feature extraction branch is trained through the second image set, so that the second feature extraction branch may emphatically learn the facial features of the second category. The third feature extraction branch is trained through the fourth image set, so that the third feature extraction branch may emphatically learn the facial features of the objects in the fourth image set, and the robustness of the third feature extraction branch may be improved. The back propagation gradient of the first modal network is obtained according to the back propagation gradient of the first feature extraction branch, the back propagation gradient of the second feature extraction branch and the back propagation gradient of the third feature extraction branch, and gradient back propagation is performed on the first modal network according to the gradient, so that all the parameter adjustment directions of the three feature extraction branches are simultaneously considered, the robustness of the first modal network subjected to parameter adjustment is high, and the recognition accuracy for target persons of the first category and the second category is high. The following embodiments are some examples of 202. For enabling the second modal network to learn the features of the first category and the second category in a more balanced manner during training based on the third image set, the preset condition may be that the first number is the same as the second number. In a possible implementation, f images are selected from the first image set and the second image set respectively so that a number of persons in the f images is a threshold to obtain the third image set. In some examples, the threshold is 1,000, the f images are selected from the first image set and the second image set respectively in the manner that the number of the persons in the f images is 1,000, f being any positive integer, and the f images selected from the first image set and the f images selected from the second image set are finally determined as the third image set. For enabling the second modal network to learn the features of the first category and the second category more pertinently during training based on the third image set, the preset condition may be that a ratio of the first number to the second number is equal to a ratio of a number of images in the first image set to a number of images in the second image set or the ratio of the first number to the second number is equal to a ratio of the number of persons in the first image set to the number of persons in the second image set. In such case, a ratio of the features, learned by the second modal network, of the first category to the features of the second category is a constant value, and the difference between the recognition standard for the first category and the recognition standard for the second category may be made up. In a possible implementation, m images and n images are selected from the first image set and the second image set respectively so that a ratio of m to n is equal to the ratio of the number of the images in the first image set to the number of the images in the second image set and the numbers of persons in the m images and the n images are both the threshold to obtain the third image set. In some examples, the first image set includes 7,000 images, the second image set includes 8,000 images, the threshold is 1,000, the numbers of the persons in the m images selected from the first image set and the n images selected from the second image set are both 1,000, m:n=7:8, n and m being any positive integers, and the m images selected from the first image set and the n images selected from the second image set are finally determined as the third image set. In another possible implementation, s images and t images are selected from the first image set and the second image set respectively so that a ratio of s to t is equal to the ratio of the number of the persons in the first image set to the number of the persons in the second image set and the numbers of persons in the s images and the t images are both the threshold to obtain the third image set. In some examples, the number of the persons in the first image set is 6,000, the number of the persons in the second image set is 7,000, the threshold is 1,000, the numbers of the persons in the s images selected from the first image set and the t images selected from the second image set are both 1,000, s:t=6:7, s and t being any positive integers, and the s images selected from the first image set and the t images selected from the second image set are finally determined as the third image set.

Some embodiments provide some manners for selecting images from the first image set and the second image set, different third image sets may be obtained in different selection manners, and different selection manners may be selected according to specific training effects and requirements.

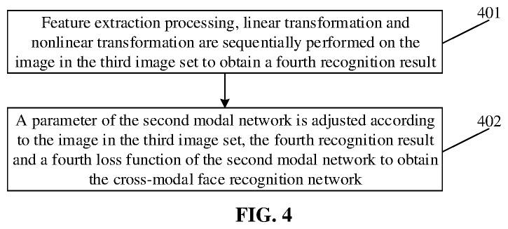

Referring to FIG. 4, FIG. 4 is a flowchart of a possible implementation of 203 according to an embodiment of the disclosure.

In operation 401, feature extraction processing, linear transformation and nonlinear transformation are sequentially performed on the image in the third image set to obtain a fourth recognition result. At first, the second modal network performs feature extraction processing on the image in the third image set. Feature extraction processing may be implemented in multiple manners, for example, convolution and pooling. No specific limits are made thereto in some embodiments of the disclosure. In some examples, the second modal network includes multiple convolutional layers, and convolution processing is performed on the image in the third image set layer by layer through the multiple convolutional layers to complete feature extraction processing of the image in the third image set. Feature contents and semantic information extracted by each convolutional layer are different. Specifically, by feature extraction processing, features of the images are abstracted step by step, and meanwhile, the relatively minor features are gradually removed. Therefore, a feature extracted later is smaller in size, and a content and semantic information are more compressed. Through the multiple convolutional layers, convolution processing is performed on the image in the third image set step by step and the corresponding features are extracted to finally obtain a feature image with a fixed size. Therefore, the size of the image may be reduced at the same time of obtaining main content information (i.e., the feature image of the image in the third image set) of the image to be processed, calculations of the system are reduced, and the operating rate is increased. In a possible implementation, an implementation process of convolution processing is as follows: convolution processing is performed on the image to be processed through the convolutional layers, namely a convolution kernel slides on the image in the third image set, pixels of the image in the third image set are multiplied by corresponding numerical values of the convolution kernel, then all values obtained by multiplication are added to obtain a pixel value, corresponding to an intermediate pixel of the convolution kernel, in the image, all the pixels in the image in the third image set are finally processed by sliding, and the corresponding feature image is extracted. The fully connected layer is connected after the convolutional layers, and linear transformation may be performed on the feature image extracted by the convolutional layers through the fully connected layer to map the features in the feature image to a sample (i.e., the serial number of the object) tagging space. The softmax layer is connected after the fully connected layer, and the extracted feature image is processed through the softmax layer to obtain the fourth recognition result. A specific composition of the softmax layer and a feature image processing process may refer to 301 and will not be elaborated herein. The fourth recognition result includes probabilities that a serial number of an object in the third image set is 1 to Z (the number of the persons in the third image set is Z) respectively, namely the fourth recognition result of each object includes Z probabilities.

In operation 402, a parameter of the second modal network is adjusted according to the image in the third image set, the fourth recognition result and a fourth loss function of the second modal network to obtain the cross-modal face recognition network. The loss function layer including the fourth loss function is connected after the softmax layer, and an expression of the fourth loss function may refer to the formula (2). Since the third image set input to the second neural network to be trained includes objects of different categories, in the process of obtaining the fourth recognition result through the softmax function, the facial features of the objects of the different categories are compared, recognition standards for the different categories are normalized, namely the objects of the different categories are recognized based on the same recognition standard, and finally, the parameter of the second modal parameter is adjusted through the fourth recognition result and the fourth loss function to enable the second modal network subjected to parameter adjustment to recognize objects of different categories based on the same recognition standard, so that the recognition accuracy for objects of different categories is improved. In some examples, the recognition standard for the first category is 0.8, the recognition standard for the second category is 0.65, and by training in operation 402, the parameter and recognition standard of the second modal network are adjusted to finally determine that the recognition standard is 0.72. Since the parameter of the second modal network may be correspondingly adjusted along with adjustment of the recognition standard, the cross-modal face recognition network obtained by parameter adjustment may reduce the difference between the recognition standard for the first category and the recognition standard for the second category.

In some embodiments of the disclosure, the second modal network is trained by taking the third image set as the training set, the facial features of objects of different categories may be compared, and the recognition standards for different categories may be normalized. The parameter of the second modal network is adjusted, so that the cross-modal face recognition network obtained by parameter adjustment may not only recognize whether objects of the first category are the same person or not with high recognition accuracy but also recognize whether objects of the second category are the same person or not with high recognition accuracy, and the difference between the recognition standards for recognizing whether objects of different categories are the same person or not is reduced. As mentioned above, the categories of the target persons in the image sets for training may be divided according to ages of the persons, may also be divided according to races and may also be divided according to districts. The disclosure provides a method for training a neural network based on image sets obtained by categorization according to races, namely the first category and the second category correspond to different races respectively, so that the recognition accuracy of the neural network for objects of different races may be improved.

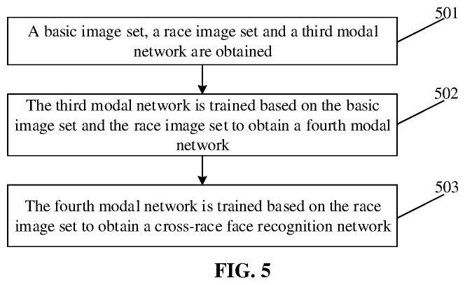

Referring to FIG. 5, FIG. 5 shows a method flow of training a neural network based on image sets obtained by categorization according to races according to the disclosure.

In operation 501, a basic image set, a race image set and a third modal network are obtained. In some embodiments of the disclosure, the basic image set may include one or more image sets. Specifically, all images in an eleventh image set are images collected indoors, all images in a twelfth image set are images collected at a port, all images in a thirteenth image set are images collected in the open air, all images in a fourteenth image set are images collected in a crowd, all images in a fifteenth image set are document images, all images in a sixteenth image set are images shot through a mobile phone, all images in a seventeenth image set are images collected through a camera, all images in an eighteenth image set are images captured from a video, all images in a nineteenth image set are images downloaded from the Internet, and all images in a twentieth image set are images obtained by processing images of famous persons. It is to be understood that all images in any image set in the basic image set are images collected in a same scenario or images collected in a same collection manner, namely the image set in the basic image set corresponds to the fourth image set in operation 301. Persons in China are categorized as a first race, persons in Thailand are categorized as a second race, persons in India are categorized as a third race, persons in Cairo are categorized as a fourth race, persons in Africa are categorized as a fifth race, and persons in the Europe are categorized as a sixth race. Correspondingly, there are six race image sets including the six races respectively. Specifically, a fifth image set includes the first race, a sixth image set includes the second race, . . . , and a tenth image set includes the sixth race. It is to be understood that all objects in any image set in the race image sets belong to the same race (i.e., the same category), namely the image set in the race image set corresponds to the first image set or second image set in operation 101.

For making the facial features of the objects in each image set representative of facial features of the corresponding category, the number of the persons in each image set is optionally larger than 5,000. It is to be understood that the number of the images in the image set is not limited in some embodiments of the disclosure. It is to be understood that another manner may also be adopted for race division. For example, races are divided according to skin colors, and four races, i.e., the yellow race, the white race, the black race and the brown race, may be obtained. The race division manner is not limited in the embodiment. Objects in the basic image set and the race image set may only include faces and may also include the faces and other parts such as trunks, and no specific limits are made thereto in the disclosure. In some embodiments, the third modal network may be any neural network with the function of extracting features from images. For example, it may be stacked or formed based on network units such as a convolutional layer, a nonlinear layer and a fully connected layer according to a certain manner, and may also adopt an existing neural network structure. A structure of the third modal network is not specifically limited in the disclosure.

In operation 502, the third modal network is trained based on the basic image set and the race image set to obtain a fourth modal network. The step may specifically refer to 201 and 301˜302, and will not be elaborated herein. It is to be understood that, since the basic image set includes ten image sets and the race image set includes six image sets, the third modal network correspondingly includes 16 feature extraction branches, namely each image set corresponds to a feature extraction branch. Through processing in operation 502, the recognition accuracy of the fourth modal network for whether objects of different races are the same person or not may be improved, namely the recognition accuracy in each race may be improved. Specifically, whether objects of the first race, the second race, the third race, the fourth race, the fifth race and the sixth race are the same person or not may be recognized through the fourth modal network with relatively high accuracy, and the robustness of the fourth modal network to recognition of images collected in different scenarios or images collected in different collection manners is high.

In operation 503, the fourth modal network is trained based on the race image set to obtain a cross-race face recognition network. The step may specifically refer to 202-203 and 401-402, and will not be elaborated herein. Through processing in operation 503, a difference between recognition standards for recognizing whether objects of different races are the same person or not by the obtained cross-race face recognition network may be reduced, and the cross-race face recognition network may improve the recognition accuracy for objects of different races. Specifically, all the accuracy of the cross-race face recognition network in recognizing whether objects belonging to the first race in different images are the same person or not, the accuracy in recognizing whether objects belonging to the second race in different images are the same person or not, . . . and the accuracy in recognizing whether objects belonging to the sixth race in different images are the same person or not are higher than a preset value. It is to be understood that the preset value represents that the recognition accuracy of the cross-race face recognition network for each race is high. A specific magnitude of the preset value is not limited in the disclosure. Optionally, the preset value is 98%. Optionally, for simultaneously improving the recognition accuracy in the races and reducing differences between recognition standards for different races, 502 and 503 may be repeated for many times. In some examples, the third modal network is trained for 100,000 rounds according to the training manner in operation 502; in subsequent 100,000th to 150,000th training rounds, the proportion of the training manner in operation 502 is gradually decreased to 0, and the proportion of the training manner in operation 503 is gradually increased to 1; training in 150,000th to 250,000th rounds is completed according to the training manner in operation 503; in subsequent 250,000th to 300,000th training rounds, the proportion of the training manner in operation 503 is gradually decreased to 0, and the proportion of the training manner in operation 502 is gradually increased to 1; and finally, in 300,000th to 400,000th training rounds, the proportions of the training manner in operation 502 and the training manner in operation 503 are 50% respectively. It is to be understood that a specific numerical value of a round number and proportions of the training manner in operation 502 and the training manner in operation 503 in each stage are not limited in some embodiments of the disclosure. The cross-race face recognition network obtained in the embodiment may be adopted to recognize whether objects of multiple races are the same person or not with high recognition accuracy. For example, the cross-race face recognition network may recognize the race in China, may also recognize the race in Cairo and may also recognize the race in the Europe, and the recognition accuracy for each race is high. Therefore, the problem that a face recognition algorithm has high recognition accuracy for a certain race but low recognition accuracy for another race may be solved. In addition, with application of the embodiment, the robustness of the cross-race face recognition network to recognition of images collected in different scenarios or in different collection manners may be improved. It can be understood by those skilled in the art that, in the method of the specific implementations, the writing sequence of each step does not mean a strict execution sequence and is not intended to form any limit to the implementation process and a specific execution sequence of each step should be determined by functions and probable internal logic thereof.

The method of the embodiments of the disclosure is elaborated above, and a device of the embodiments of the disclosure will be provided below.

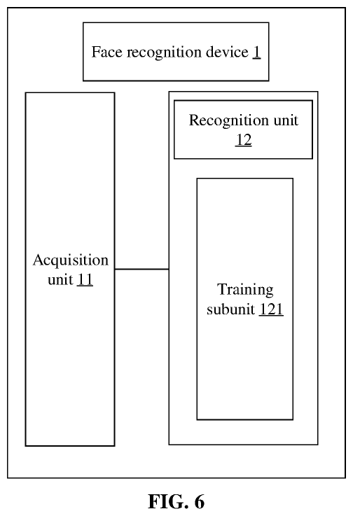

Referring to FIG. 6, FIG. 6 is a structure diagram of a face recognition device according to an embodiment of the disclosure. The recognition device 1 includes an acquisition unit 11 and a recognition unit 12. The acquisition unit 11 is configured to acquire an image to be recognized. The recognition unit 12 is configured to recognize the image to be recognized based on a cross-modal face recognition network to obtain a recognition result of the image to be recognized, where the cross-modal face recognition network is obtained by training based on face image data in different modalities.

Furthermore, the recognition unit 12 includes a training subunit 121, configured to obtain the cross-modal face recognition network by training based on a first modal network and a second modal network.

Furthermore, the training subunit 121 is further configured to train the first modal network based on a first image set and a second image set, where an object in the first image set belongs to a first category, and an object in the second image set belongs to a second category. Furthermore, the training subunit 121 is further configured to: train the first modal network based on the first image set and the second image set to obtain the second modal network; select a first number of images in the first image set and a second number of images in the second image set according to a preset condition and obtain a third image set according to the first number of images and the second number of images; and train the second modal network based on the third image set to obtain the cross-modal face recognition network. Furthermore, the preset condition includes any one of: the first number is the same as the second number, a ratio of the first number to the second number is equal to a ratio of a number of images in the first image set to a number of images in the second image set, or the ratio of the first number to the second number is equal to a ratio of a number of persons in the first image set to a number of persons in the second image set. Furthermore, the first modal network includes a first feature extraction branch, a second feature extraction branch and a third feature extraction branch, and the training subunit 121 is further configured to: train the first modal network by inputting the first image set to the first feature extraction branch, inputting the second image set to the second feature extraction branch and inputting a fourth image set to the third feature extraction branch, where images in the fourth image set are images collected in a same scenario or images collected in a same collection manner; and determine a trained first feature extraction branch or a trained second feature extraction branch or a trained third feature extraction branch as the second modal network. Furthermore, the training subunit 121 is further configured to: input the first image set, the second image set and the fourth image set to the first feature extraction branch, the second feature extraction branch and the third feature extraction branch respectively to obtain a first recognition result, a second recognition result and a third recognition result respectively; acquire a first loss function of the first feature extraction branch, a second loss function of the second feature extraction branch and a third loss function of the third feature extraction branch; and adjust a parameter of the first modal network according to the first image set as well as the first recognition result and the first loss function, the second image set as well as the second recognition result and the second loss function, and the fourth image set as well as the third recognition result and the third loss function to obtain an adjusted first modal network, where the parameter of the first modal network includes a parameter of the first feature extraction branch, a parameter of the second feature extraction branch and a parameter of the third feature extraction branch, and the parameters of the three branches of the adjusted first modal network are identical to each other. Furthermore, the image in the first image set includes first labeling information, the image in the second image set includes second labeling information, the image in the fourth image set includes third labeling information, and the training subunit 121 is further configured to: obtain a first gradient according to the first labeling information, the first recognition result, the first loss function and an initial parameter of the first feature extraction branch, obtain a second gradient according to the second labeling information, the second recognition result, the second loss function and an initial parameter of the second feature extraction branch and obtain a third gradient according to the third labeling information, the third recognition result, the third loss function and an initial parameter of the third feature extraction branch; and determine an average value of the first gradient, the second gradient and the third gradient as a back propagation gradient of the first modal network and adjust the parameter of the first modal network through the back propagation gradient, so that the parameter of the first feature extraction branch, the parameter of the second feature extraction branch and the parameter of the third feature extraction branch are identical to each other. Furthermore, the training subunit 121 is further configured to: select f images from the first image set and the second image set respectively so that a number of persons in the f images is a threshold to obtain the third image set; or, select m images and n images from the first image set and the second image set respectively so that a ratio of m to n is equal to the ratio of the number of the images in the first image set to the number of the images in the second image set and the numbers of persons in the m images and the n images are both the threshold to obtain the third image set; or, select s images and t images from the first image set and the second image set respectively so that a ratio of s to t is equal to the ratio of the number of the persons in the first image set to the number of the persons in the second image set and the numbers of persons in the s images and the t images are both the threshold to obtain the third image set. Furthermore, the training subunit 121 is further configured to: sequentially perform feature extraction processing, linear transformation and nonlinear transformation on the image in the third image set to obtain a fourth recognition result; and adjust a parameter of the second modal network according to the image in the third image set, the fourth recognition result and a fourth loss function of the second modal network to obtain the cross-modal face recognition network. Furthermore, the first category and the second category correspond to different races. In some embodiments, functions or modules of the device provided in some embodiments of the disclosure may be configured to execute the method described in the method embodiment and specific implementation thereof may refer to the descriptions about the method embodiment and, for simplicity, will not be elaborated herein.

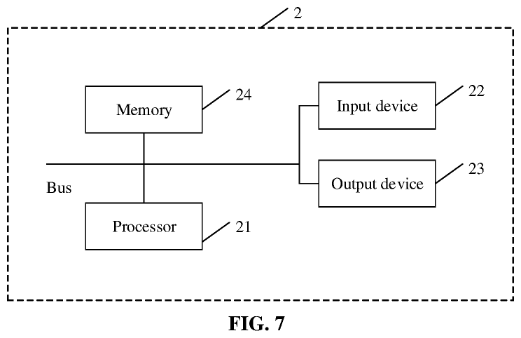

FIG. 7 is a hardware structure diagram of a face recognition device according to an embodiment of the disclosure. The recognition device 2 includes a processor 21, and may further include an input device 22, an output device 23 and a memory 24. The input device 22, the output device 23, the memory 24 and the processor 21 are connected with one another through a bus. The memory includes, but not limited to, a Random Access Memory (RAM), a Read-Only Memory (ROM), an Erasable Programmable ROM (EPROM) or a Compact Disc Read-Only Memory (CD-ROM). The memory is configured for related instructions and data. The input device is configured to input data and/or signals, and the output device is configured to output data and/or signals. The output device and the input device may be independent devices and may also be integrated. The processor may include one or more processors, for example, including one or more Central Processing Units (CPUs). Under the condition that the processor is a CPU, the CPU may be a single-core CPU and may also be a multi-core CPU. The memory is configured to store a program code and data of a network device. The processor is configured to call the program code and data in the memory to execute the steps in the method embodiment, specifically referring to the descriptions in the method embodiment. Elaborations are omitted herein. It can be understood that FIG. 7 only shows a simplified design of the face recognition device. During a practical application, the face recognition device may further include other required components, including, but not limited to, any number of input/output devices, processors, controllers, memories and the like. All face recognition devices capable of implementing the embodiments of the disclosure fall within the scope of protection of the disclosure. Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure. Those skilled in the art may clearly learn about that specific working processes of the system, device and unit described above may refer to the corresponding processes in the method embodiment and will not be elaborated herein for convenient and brief description. Those skilled in the art may also clearly know that the embodiments of the disclosure are described with different focuses. For convenient and brief description, elaborations about the same or similar parts may be omitted in different embodiments, and thus parts that are not described or detailed in an embodiment may refer to records in the other embodiments. In some embodiments provided by the disclosure, it is to be understood that the disclosed system, device and method may be implemented in another manner For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms. The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit. The embodiments may be implemented completely or partially through software, hardware, firmware or any combination thereof. During implementation with the software, the embodiments may be implemented completely or partially in form of computer program product. The computer program product includes one or more computer instructions. When the computer program instruction is loaded and executed on a computer, the flows or functions according to the embodiments of the disclosure are completely or partially generated. The computer may be a universal computer, a dedicated computer, a computer network or another programmable device. The computer instruction may be stored in a computer-readable storage medium or transmitted through the computer-readable storage medium. The computer instruction may be transmitted from one website, computer, server or data center to another website, computer, server or data center in a wired (for example, a coaxial cable, an optical fiber and a Digital Subscriber Line (DSL)) or wireless (for example, infrared, radio and microwave) manner The computer-readable storage medium may be any available medium accessible for the computer or a data storage device, such as a server and a data center, including one or more integrated available media. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It can be understood by those of ordinary skill in the art that all or part of the flows in the method of the abovementioned embodiments may be completed by instructing related hardware through a computer program, the program may be stored in a computer-readable storage medium, and when the program is executed, the flows of each method embodiment may be included. The abovementioned storage medium includes various media capable of storing program codes such as a ROM or RAM, a magnetic disk or an optical disk. For making the purpose, technical solutions and advantages of the embodiments of the disclosure clearer, the specific technical solutions of the disclosure will further be described below in combination with the drawings in the embodiments of the disclosure in detail. The following embodiments are adopted to describe the disclosure but not intended to limit the scope of the disclosure.

1. A face recognition method, comprising:
acquiring an image to be recognized; and
recognizing the image to be recognized based on a cross-modal face recognition network to obtain a recognition result of the image to be recognized, wherein the cross-modal face recognition network is obtained by training based on face image data in different modalities.

2. The method of claim 1, wherein a process of obtaining the cross-modal face recognition network by training based on the face image data in the different modalities comprises:
obtaining the cross-modal face recognition network by training based on a first modal network and a second modal network.

3. The method of claim 2, further comprising: before obtaining the cross-modal face recognition network by training based on the first modal network and the second modal network,
training the first modal network based on a first image set and a second image set, wherein an object in the first image set belongs to a first category, and an object in the second image set belongs to a second category.

4. The method of claim 3, wherein training the first modal network based on the first image set and the second image set comprises:
training the first modal network based on the first image set and the second image set to obtain the second modal network;
selecting a first number of images in the first image set and a second number of images in the second image set according to a preset condition, and obtaining a third image set according to the first number of images and the second number of images; and
training the second modal network based on the third image set to obtain the cross-modal face recognition network.

5. The method of claim 4, wherein the preset condition comprises any one of: the first number is the same as the second number, a ratio of the first number to the second number is equal to a ratio of a number of images in the first image set to a number of images in the second image set, or the ratio of the first number to the second number is equal to a ratio of a number of persons in the first image set to a number of persons in the second image set.

6. The method of claim 2, wherein the first modal network comprises a first feature extraction branch, a second feature extraction branch and a third feature extraction branch, and wherein training the first modal network based on the first image set and the second image set to obtain the second modal network comprises:
training the first modal network by inputting the first image set to the first feature extraction branch, inputting the second image set to the second feature extraction branch and inputting a fourth image set to the third feature extraction branch, wherein images in the fourth image set are images collected in a same scenario or images collected in a same collection manner; and
determining a trained first feature extraction branch or a trained second feature extraction branch or a trained third feature extraction branch as the second modal network.

7. The method of claim 6, wherein training the first modal network by inputting the first image set to the first feature extraction branch, inputting the second image set to the second feature extraction branch and inputting the fourth image set to the third feature extraction branch comprises:
inputting the first image set, the second image set and the fourth image set to the first feature extraction branch, the second feature extraction branch and the third feature extraction branch respectively to obtain a first recognition result, a second recognition result and a third recognition result respectively;
acquiring a first loss function of the first feature extraction branch, a second loss function of the second feature extraction branch and a third loss function of the third feature extraction branch; and
adjusting a parameter of the first modal network according to the first image set as well as the first recognition result and the first loss function, the second image set as well as the second recognition result and the second loss function, and the fourth image set as well as the third recognition result and the third loss function to obtain an adjusted first modal network, wherein the parameter of the first modal network comprises a parameter of the first feature extraction branch, a parameter of the second feature extraction branch and a parameter of the third feature extraction branch, and the parameters of the three branches of the adjusted first modal network are identical to each other.

8. The method of claim 7, wherein the image in the first image set comprises first labeling information, the image in the second image set comprises second labeling information, the image in the fourth image set comprises third labeling information, and
wherein adjusting the parameter of the first modal network according to the first image set as well as the first recognition result and the first loss function, the second image set as well as the second recognition result and the second loss function, and the fourth image set as well as the third recognition result and the third loss function to obtain the adjusted first modal network comprises:
obtaining a first gradient according to the first labeling information, the first recognition result, the first loss function and an initial parameter of the first feature extraction branch, obtaining a second gradient according to the second labeling information, the second recognition result, the second loss function and an initial parameter of the second feature extraction branch, and obtaining a third gradient according to the third labeling information, the third recognition result, the third loss function and an initial parameter of the third feature extraction branch; and
determining an average value of the first gradient, the second gradient and the third gradient as a back propagation gradient of the first modal network, and adjusting the parameter of the first modal network through the back propagation gradient, so that the parameter of the first feature extraction branch, the parameter of the second feature extraction branch and the parameter of the third feature extraction branch are identical to each other.

9. The method of claim 4, wherein selecting the first number of images in the first image set and the second number of images in the second image set according to the preset condition to obtain the third image set comprises:
selecting f images from the first image set and the second image set respectively so that a number of persons in the f images is a threshold, to obtain the third image set; or, selecting m images and n images from the first image set and the second image set respectively so that a ratio of m to n is equal to the ratio of the number of the images in the first image set to the number of the images in the second image set and the numbers of persons in the m images and the n images are both the threshold, to obtain the third image set; or,
selecting s images and t images from the first image set and the second image set respectively so that a ratio of s to t is equal to the ratio of the number of the persons in the first image set to the number of the persons in the second image set and the numbers of persons in the s images and the t images are both the threshold, to obtain the third image set.

10. The method of claim 3, wherein training the second modal network based on the third image set to obtain the cross-modal face recognition network comprises:
sequentially performing feature extraction processing, linear transformation and nonlinear transformation on an image in the third image set to obtain a fourth recognition result; and
adjusting a parameter of the second modal network according to the image in the third image set, the fourth recognition result and a fourth loss function of the second modal network to obtain the cross-modal face recognition network.

11. The method of claim 1, wherein the first category and the second category correspond to different races.

12. A face recognition device, comprising:
a memory storing processor-executable instructions; and
a processor configured to execute the stored processor-executable instructions to perform operations of:
acquiring an image to be recognized; and
recognizing the image to be recognized based on a cross-modal face recognition network to obtain a recognition result of the image to be recognized, wherein the cross-modal face recognition network is obtained by training based on face image data in different modalities.

13. The device of claim 12, wherein a process of obtaining the cross-modal face recognition network by training based on the face image data in the different modalities comprises:
obtaining the cross-modal face recognition network by training based on a first modal network and a second modal network.

14. The device of claim 13, wherein the processor is configured to execute the stored processor-executable instructions to further perform an operations of:
training the first modal network based on a first image set and a second image set, wherein an object in the first image set belongs to a first category, and an object in the second image set belongs to a second category.

15. The device of claim 14, wherein training the first modal network based on the first image set and the second image set comprises:
training the first modal network based on the first image set and the second image set to obtain the second modal network;
selecting a first number of images in the first image set and a second number of images in the second image set according to a preset condition, and obtaining a third image set according to the first number of images and the second number of images; and
training the second modal network based on the third image set to obtain the cross-modal face recognition network.

16. The device of claim 15, wherein the preset condition comprises any one of: the first number is the same as the second number, a ratio of the first number to the second number is equal to a ratio of a number of images in the first image set to a number of images in the second image set, or the ratio of the first number to the second number is equal to a ratio of a number of persons in the first image set to a number of persons in the second image set.

17. The device of claim 13, wherein the first modal network comprises a first feature extraction branch, a second feature extraction branch and a third feature extraction branch, and
wherein training the first modal network based on the first image set and the second image set to obtain the second modal network comprises:
training the first modal network by inputting the first image set to the first feature extraction branch, inputting the second image set to the second feature extraction branch and inputting a fourth image set to the third feature extraction branch, wherein images in the fourth image set are images collected in a same scenario or images collected in a same collection manner; and
determining a trained first feature extraction branch or a trained second feature extraction branch or a trained third feature extraction branch as the second modal network.

18. The device of claim 17, wherein training the first modal network by inputting the first image set to the first feature extraction branch, inputting the second image set to the second feature extraction branch and inputting the fourth image set to the third feature extraction branch comprises:
inputting the first image set, the second image set and the fourth image set to the first feature extraction branch, the second feature extraction branch and the third feature extraction branch respectively to obtain a first recognition result, a second recognition result and a third recognition result respectively;
acquiring a first loss function of the first feature extraction branch, a second loss function of the second feature extraction branch and a third loss function of the third feature extraction branch; and
adjusting a parameter of the first modal network according to the first image set as well as the first recognition result and the first loss function, the second image set as well as the second recognition result and the second loss function, and the fourth image set as well as the third recognition result and the third loss function to obtain an adjusted first modal network, wherein the parameter of the first modal network comprises a parameter of the first feature extraction branch, a parameter of the second feature extraction branch and a parameter of the third feature extraction branch, and the parameters of the three branches of the adjusted first modal network are identical to each other.

19. The device of claim 18, wherein the image in the first image set comprises first labeling information, the image in the second image set comprises second labeling information, the image in the fourth image set comprises third labeling information, and
wherein adjusting the parameter of the first modal network according to the first image set as well as the first recognition result and the first loss function, the second image set as well as the second recognition result and the second loss function, and the fourth image set as well as the third recognition result and the third loss function to obtain the adjusted first modal network comprises:
obtaining a first gradient according to the first labeling information, the first recognition result, the first loss function and an initial parameter of the first feature extraction branch, obtaining a second gradient according to the second labeling information, the second recognition result, the second loss function and an initial parameter of the second feature extraction branch, and obtaining a third gradient according to the third labeling information, the third recognition result, the third loss function and an initial parameter of the third feature extraction branch; and
determining an average value of the first gradient, the second gradient and the third gradient as a back propagation gradient of the first modal network and adjust the parameter of the first modal network through the back propagation gradient, so that the parameter of the first feature extraction branch, the parameter of the second feature extraction branch and the parameter of the third feature extraction branch are identical to each other.

20. A non-transitory computer-readable storage medium having stored thereon computer-executable instructions that, when executed by a processor, cause the processor to perform operations of:
acquiring an image to be recognized; and
recognizing the image to be recognized based on a cross-modal face recognition network to obtain a recognition result of the image to be recognized, wherein the cross-modal face recognition network is obtained by training based on face image data in different modalities.
